(19) United States
(12) Patent Application Publication
(10) Pub. No.: US 2024/0335268 A1
(43) Pub. Date: Oct. 10, 2024

(54) MICROCAPSULE FOR USE IN THE TREATMENT OF TOOTH MISALIGNMENT BY MEANS OF PLASTIC SPLINTS OR ALIGNERS

(71) Applicant: DENTSPLY SIRONA Inc., York, PA (US)

(72) Inventors: Christoph BRANDES, Mannheim (DE); Jonathan Merlin VAN KEMPEN, Bensheim (DE)

(73) Assignee: DENTSPLY SIRONA Inc., York, PA (US)

(21) Appl. No.: 18/576,575

(22) PCT Filed: Jul. 4, 2022
(86) PCT No.: PCT/EP2022/068431

§ 371 Date: Jan. 4, 2024

(30) Foreign Application Priority Data
Jul. 5, 2021 (EP) 21183816.4

(51) Int. Cl. A61C 19/05; A61C 7/08; G01L 1/24

(52) U.S. Cl. CPC A61C 19/052; A61C 7/08; G01L 1/247; A61C 2201/002

(57) ABSTRACT

A microcapsule for use in the treatment of dental malocclusions/misalignments based on plastic splints or aligners. The microcapsule is a few μm, such as 0.5 μm to 200 μm in size and has a shell made of plastic or glass or ceramic, the shell is filled with a liquid in the interior, and the shell breaks open when it experiences a force and releases the liquid, which can be detected optically, for example, by a color change or illumination with UV light.

The entire content of the priority application EP21183816.4 is hereby incorporated by reference to this international application under the provisions of the PCT.

### TECHNICAL FIELD OF THE INVENTION

The present invention relates to orthodontic treatment methods, in particular to the treatment of malocclusions/misalignments by means of plastic splints or aligner therapy.

### BACKGROUND OF THE INVENTION

Aligner therapy is an orthodontic treatment method for the largely invisible treatment of mild to severe tooth misalignments that works with a sequence of individually manufactured, thin and transparent plastic splints (aligner). The plastic splints are manufactured by deep drawing of thermoform foils or by additive manufacturing processes such as 3D printing.

For the success of the therapy, it is necessary that the aligners apply a sufficiently high force on the tooth. In the course of wearing the aligner, the plastic material from which the aligner was manufactured deforms. As a result, the force applied to the tooth gives way and an effective therapy can no longer be guaranteed. Therefore, the dentist uses a new aligner at regular intervals so that the therapy can be continued successfully.

It is important for the effectiveness of the therapy that the aligners are of consistent quality over the duration of use, as possible.

### DISCLOSURE OF THE INVENTION

Currently, the inventors are not aware of any prior art with which the physician/patient can easily determine the effectiveness of the treatment and track the progress of the treatment and, for example, determine the changeover time for a new aligner.

The objective of the present invention is to provide microcapsules with which the efficacy of the therapy can be determined, and the progress of the therapy can be monitored.

This objective has been achieved by the microcapsule according to claim 1. The subject-matters of the dependent claims relate to further developments and preferred embodiments.

The microcapsule according to the invention can be used in the treatment of tooth malocclusions/misalignments by means of plastic splints or aligners. The microcapsule is a few μm in size (preferably 0.5 μm-200 μm) and has a shell made of plastic, glass or ceramic. The shell is filled inside with a biocompatible liquid. The shell ruptures when it experiences a defined force and the liquid, which can be detected optically preferably by a color change or UV light, is released.

The microcapsule is applied between the tooth and the inner side of the aligner. The microcapsules can preferably be applied in various ways: e.g., as a spray, paste, powder, foil, or adhesive foil.

The microcapsules can be applied not only by the physician, but by the patient. The physician can determine the effectiveness of the therapy and follow the progress of the therapy. The patient can determine when to change the aligner and visit the physician or change it according to the instructions for use.

According to the present invention, it is possible to determine whether the minimum necessary force is applied to the tooth by the aligners.

According to the present invention, it is also possible to determine whether the force on the teeth falls below or exceeds a necessary limit value during the course of wearing the aligner. The determination of the force can be take place very locally.

According to the present invention, it is further made possible for the physician/patient to have the time of changing the aligner visually indicated by means of the microcapsules.

Preferably, the microcapsule is filled with a colored liquid to create a color effect and allow the physician/patient to visualize when it breaks. The colors in the microcapsules may be transparent in the visible wavelength range and acquire their hue only after the microcapsule breaks. The color change in this case can result from a change in pH or oxidation of the dye. Also, the color change may be possible by the reaction of two or more used substances in the microcapsules with the same or different sensitivities/forces for rupture.

Preferably, a combination or mixtures of different types of microcapsules with different colors, and each with different sensitivities/forces for rupture can be used to achieve a force resolution and to visualize this to the physician/patient. This allows a wider range of forces to be determined.

### BRIEF DESCRIPTION OF THE DRAWINGS

In the following description, the present invention will be explained in more detail by means of exemplary embodiments with reference to the drawings, whereby

FIG. 1-shows a schematic cross-sectional view of a microcapsule according to one embodiment of the invention;

FIG. 2-shows a schematic view of an aligner from below on whose inner side microcapsules have been applied;

FIG. 3-shows a schematic front view of an aligner with microcapsules applied to the inner side.

The reference numbers shown in the drawings designate the elements listed below, which are referred to in the following description of the exemplary embodiments.
1 Microcapsule
2. Shell
3. Liquid
4. Dye
5. Aligner/Plastic splint

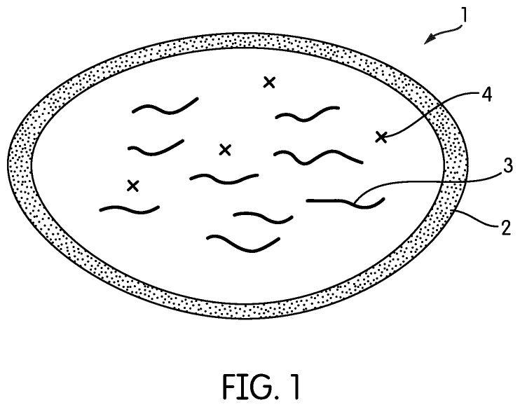

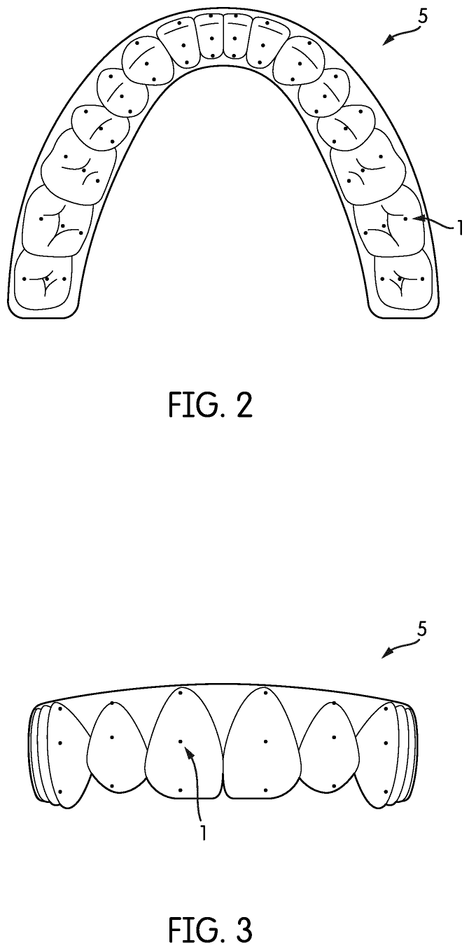

FIG. 1 shows a microcapsule (1) according to one embodiment. According to the present invention, microcapsules (1) are used in the treatment of tooth malocclusions or misalignments by means of plastic splints (5) or aligners (5). These are a few μm in size and each has a shell (2) made of plastic or glass or ceramic. The shell (2) is filled with a liquid (3) on the inside. Furthermore, the shell (2) breaks open when it experiences a defined force, and the liquid (3), which can be detected optically preferably by a color change or UV light, is released.

According to a preferred embodiment, the microcapsules (1) can be filled with a liquid (3) which is or becomes colored upon release.

For the successful application of an aligner (5), it must apply forces between 0.05N and 5N to a tooth, depending on the planned treatment. This results in a compressive stress X=0.01 to 1 MPa which occurs between the tooth and the aligner (5). If the microcapsules (1), which are sensitive to the compressive stress X, are applied between the tooth and the aligner, a liquid discharge, preferably coloration, occurs when the force and thus the stress is reached. If the force is not reached, no liquid (3) is released, and no color effect occurs. According to a preferred embodiment, different microcapsules (1) are combined. Depending on the intended marking and color, differently filled or differently sensitive microcapsules (1) can be used. Different dyes (4) can be used with different sensitive microcapsules (1), for example a yellow and a green dye, which turn blue when released together. Thus, a force resolution can be achieved.

This is explained with the following example:
Microcapsule (1) according to type A reacts at 0, 5 MPa and turns yellow
Microcapsule (1) according to type B reacts at 1.0 MPa and turns green

At stresses below 0.5 MPa, no coloration occurs. At stresses between 0.5 MPa-1.0 MPa, yellow coloration occurs. At stresses >1.0 MPa, blue coloration occurs (i.e. yellow+green). Three or more different microcapsules (1) can also be combined for an even wider force resolution.

The application of the microcapsules (1) can be carried out in various ways. According to different embodiments, the microcapsules (1) are provided as a spray, a paste, a film, preferably an adhesive film, or a powder. The spray, paste, foil and powder can be manufactured, for example, from different types of microcapsules (1) or, alternatively, from only one type of microcapsules (1).

1. A Microcapsule for use in the treatment of dental malocclusions using plastic splints or aligners, comprising:
a shell made of plastic or glass or ceramic, the shell is filled in the interior with a liquid, and the shell breaks open when it experiences a defined force and releases the liquid, which can be detected optically preferably by a color change or illumination with UV light,
wherein the microcapsule has a size of 0.5 μm to 200 μm.

2. The microcapsule (1) according to claim 1, wherein the filled liquid is colored upon release.

3. A combination of microcapsules according to claim 1, wherein the combination of microcapsules have liquid with different colors on release and each microcapsule of the combination of microcapsules break open at differently defined forces.

4. A spray for use in the treatment of dental malocclusions by plastic splints or aligners wherein the spray comprises a type or combination of different types of microcapsules according to claim 1.

5. A paste for use in the treatment of dental malocclusions by plastic splints or aligners wherein the paste comprises a type or combination of different types of microcapsules according to claim 1.

6. A foil for use in the treatment of dental malocclusions by plastic splints or aligners wherein the foil comprises a type or combination of different types of microcapsules according to claim 1.

7. (canceled)

8. A powder for use in the treatment of dental malocclusions by plastic splints or aligners characterized in that the powder comprises a type or combination of different types of microcapsules according to claim 1.
